(19) United States
(12) Patent Application Publication
(10) Pub. No.: US 2022/0081517 A1
(43) Pub. Date: Mar. 17, 2022

(54) METHOD FOR SEPARATING AND RECOVERING LIGNIN and MELTABLE FLOWABLE BIOLIGNIN POLYMERS

(71) Applicant: Attis IP, LLC, MILTON, GA (US)

(72) Inventors: DAVID J. WINSNESS, MILTON, GA (US); MICHAEL J. RIEBEL, MANKATO, MN (US); MILTON J. RIEBEL, MANKATO, MN (US)

(21) Appl. No.: 17/216,531

(22) Filed: Mar. 29, 2021

Related U.S. Application Data
(63) Continuation of application No. 16/119,030, filed on Aug. 31, 2018, now abandoned.
(60) Provisional application No. 62/552,468, filed on Aug. 31, 2017.

(51) Int. Cl. C08H 8/00; C08L 55/02; C08L 31/04; C08K 5/092; C08L 97/02; C08K 5/05; C08K 5/053; C08L 23/06; C08L 97/00

(52) U.S. Cl. CPC C08H 8/00; C08L 55/02; C08L 31/04; C08K 5/092; C08L 2205/03; C08K 5/05; C08K 5/053; C08L 23/06; C08L 97/005; C08L 97/02

(57) ABSTRACT

Lignin is recovered from biomass or byproducts from biomass processing through the use of organic solvents and water while modifying the form or composition of the lignin. During the separation and recovery process, the lignin can be modified or integrated into a form which is more suitable for its intended use. As the lignin is suspended or is soluble within the organic solvent, the integration of materials or reactants may be more easily blended or dispersed within the lignin to improve performance, quality and overall production efficiency.

### TECHNICAL FIELD

The present invention is directed to a method for separating and recovering a lignin based co-product from kraft, sulfite, and alcohol pulping operations as well as from cellulosic biorefinery processes and/or essentially any plant based material that contains lignin. In addition, the recovery process may include a method to convert lignin, or the recovered lignin into a usable form that is more suitable for its intended use.

The present invention generally relates to various biopolymer lignin materials and compositions in which a secondary component is added to provide meltable, flowable, or reacted biopolymeric lignin compounds useful for adhesives, resins, thermoplastics, composites, and polymers. The invention also includes the addition of a third component comprising a carrier, dissolving agent, or reactive material to adjust material characteristics to meet specific end user applications.

### BACKGROUND OF THE INVENTION

Traditional pulping industries have predominantly focused on efficiently recovering cellulose (pulp) and little else. These existing pulp mills are relatively efficient in recovering cellulose but they do not lend themselves well to biorefinery initiatives as they are ineffective when it comes to recovering lignin and hemicellulose. The existing pulp mills predominantly burn the lignin and hemicellulose and therefore receive negligible value for these otherwise valuable components.

A few technologies have been developed to recover quality lignin from alkaline pulping (also referred to as kraft or sulfate pulping) operations but very few have been practiced in comparison to the number of kraft pulping operations in existence. Resistance to use these lignin recovery technologies has mostly been a result of a combination of high capital cost, poor efficiency, safety and poor lignin quality. While the lignin recovery method is fairly straight forward by precipitation as the PH of the kraft black liquor is reduced, the resultant product is often in the form of a wet cake containing moisture that requires removal. Removing moisture from lignin has been costly and a safety concern due to its fine particle size and high energy content. An improved method is needed to allow kraft mills to more effectively recover lignin cost effectively while optimizing the process to safely allow for the recovered lignin to be more compatible with its intended use.

As the traditional pulping industry is focused only on recovering pulp, they are dependent on the pulp price. If the price of pulp goes down, these mills suffer greatly and many are often forced to shut down where hundreds or thousands of jobs are lost. As pulp is the only valuable product produced, these traditional pulp companies have to price their products high enough so that they can recover most or all of their expenses from that single product. While pulp can be converted into biofuels, the cost of the pulp is overly expensive and therefore biofuel production is not economical. A true biorefinery would allow the recovery of more value from biomass and therefore potentially allow for sustainable biofuels and/or biomaterials production.

Next generation biorefineries are those that can efficiently separate, recover and use most or all of the materials within biomass. Conventional pulping mills use a recovery boiler where it is used to incinerate the organic materials and leave behind a sodium smelt that is then further processed and recycled for use as the alkaline pulping solvent. While lignin can be recovered from the kraft black liquor prior to the recovery boiler, only a portion can be removed without suffering operational issues in the recovery boiler. It is generally recognized that one should not exceed recovery of more than 30% of the lignin from within the kraft black liquor. This limitation is one of the reasons that resulted in the development of advanced pulping systems which could allow for the separation and recovery of greater percentages lignin and/or hemicellulose and/or other constituents of the biomass. The organosolv process is one such method as it uses organic solvents such as alcohols and by doing so can more effectively separate and recover cellulose, hemicellulose and lignin. In contrast to traditional alkaline pulping, organosolv biorefineries have many products that can be produced which can improve the sustainability of the business. For example, organosolv systems can sell pulp, hemicellulose and lignin separately or they may wish to further process these materials into higher valued materials and products before selling them.

The resistance to the construction of commercial scale organosolv biorefineries has largely been a result of the relatively high capital and operating cost associated with them. In addition, the downstream markets for the additional materials, such as hemicellulose and/or lignin, have not been able to justify the additional capital and operating costs. There needs to be a more cost effective and safe lignin recovery method and ideally one that allows the lignin to be better suited for its intended use.

Lignin is found in the cell walls of vascular plants and in the woody stems of hardwoods and softwoods. Along with cellulose and hemicellulose, lignin forms the major components of the cell wall of these vascular plants and woods. Lignin acts as a matrix material that binds the plant polysaccharides, microfibrils, and fibers, thereby imparting strength and rigidity to the plant stem. Total lignin content can vary from plant to plant. For example, in hardwoods and softwoods, lignin content can range from about 15% to about 40%.

Lignin is a naturally occurring polymer that exhibits no measurable melting point, but rather, upon exposure to elevated temperatures of greater than 120° C., undergoes thermal decomposition. For that reason, its application as a thermoplastic material has been significantly limited with much of its commercial use found in asphalt. Lignin may have a high melting point, under certain conditions, typically around 482° F. to 527° F. which is much higher than typical plastic is processed. Again at this temperature thermal degradation also is problematic. Conventional attempts have been used to melt blend lignin in a rubbery state or within its glass transition. Glass transition temperatures for softwood kraft lignin Tg have been reported from 169° C. to 180° C. Thus lignin has poor flowability and processing in extrusion or injection molding processes which are typically done at much lower temperatures than the melting point of lignin.

Lignin does not have a Melt Flow Index at temperature ranges for thermoplastic processing, thus has a significant negative effect when added to plastics. Even at theoretical melting temperatures of lignin (over 500° F.), the lignin degrades and this temperature is too high for most thermoplastics which can also degrade at these high temperatures.

Conventional techniques within lignin plastics or polymers field start with a dried lignin powder which is processed at relatively high temperatures to work with thermoplastics. The dried powder is problematic and these methods typically end up wherein the lignin powder acts more like a filler or nano filler within plastic composites. Thus when various attempts have been made to integrate lignin with plastics, the resulting material becomes stiff and brittle and acts similar to most standard mineral fillers.

In order to create lignin biopolymers and bioplastics, the lignin material must provide both the ability to be melted and have a melt flow. In addition lignin biopolymers, bioplastics, and biocomposites also require toughness, resilience and specific properties similar to that of various petrochemical products it wishes to replace. Conventional lignin separation processes and resulting materials only provide for a powder filler type of material with no melt point or flowability within normal plastic or polymer processing temperatures or processes.

Various attempts have been made to use powdered lignin in plastics applications. U.S. Pat. No. 9,453,129 to Naskar, teaches of a lignin nitrile rubber composition using dry lignin powder with nitrile rubber or acrylonitrile butadiene wherein the lignin acts as a nano filler. This is limited due to the poor flowability and rheology of the lignin as compared to plastic it wishes to replace. In addition, at lignin loading levels of greater than 50%, the material becomes brittle. With over shearing to break down the lignin, the nitrile rubber has the tendency to degrade easily. These teachings decrease the melt flow significantly wherein it is difficult to extrude or injection mold.

Other attempts describe dissolving lignin and casting lignin such as US Patent Application Publication No. 2017/01667449 to Simo Sarkanen which dissolves lignin and casts it into various shapes. The resulting lignin plastic is very brittle and generally has poor elongation characteristics of typically less than 5% wherein many plastics applications require a high degree of toughness and an elongation performance of greater than 100%.

There is a need to create new generations of biopolymers, bioplastics, biocomposites and biofuels from lignin, a renewable resource, that perform as well or better as those materials otherwise produced from fossil fuels while being produced at a lower cost.

### Object of the Invention

It is the object of this invention to create processes to extract, purify and/or modify lignin in a solid or liquid form from feedstocks that include but are not limited to biomass or agricultural byproduct streams such as black liquor from pulp and paper production facilities or cellulosic biorefinery byproduct streams.

It is the further object of this invention to create processes which integrates carriers, plasticizers, functional additives, and or dissolving agents that further lower the cost of processing and provides novel biolignin materials with a melting point and flowability similar to that of petrochemical resins, plastics and polymers.

It is the object of this invention to provide a modified process to produce a concentrated form of lignin, in solid or liquid form, from biomass or agricultural byproduct such as black liquor or cellulosic biorefinery byproducts, wherein various functional additives or processing fluids can be added to retain the lignin in a concentrated functionalized melt flowable state.

It is the object of this invention to modify the lignin with a second or third components in a liquid or melt flowable state which allows for new method of for the removal or moisture, solvents or blends thereof.

It is the object of this invention wherein various carrier materials can be added to assist in separation and drying to produce a meltable form of lignin that can be used within thermoplastic or thermoset applications.

It is the object of this invention wherein the second or third component is a carrier, plasticizer, dissolving agent, functional additive or blends thereof as to create new grades of meltable biolignin plastics, polymers, adhesives, hot melts, glues, thermosets, or composites.

It is the objective of this invention is to recover and/or convert lignin into a biofuel.

### SUMMARY OF THE INVENTION

The present invention is directed to recovering lignin more effectively from essentially any plant based material that contains lignin and/or to better prepare or convert lignin for its intended use. These lignin containing plant based materials include biomass and agricultural byproducts that include but are not limited to black liquor from pulp and paper operations, cellulosic biorefinery byproducts, black liquor from organosolv processing or directly from raw biomass itself.

For existing pulping operations that use alkaline, or kraft, processing techniques, the process of the present invention can involve a lignin concentration step followed by an organic solvent purification and recovery step. The concentration step involves recovering the lignin from black liquor or concentrated black liquor by first carbonating the black liquor with carbon dioxide to reduce the PH and to allow the lignin within to precipitate. As the kraft black liquor PH is reduced through the addition of CO₂, the lignin within will begin to precipitate and can be separated or filtered from the solution as described for example in U.S. Pat. No. 8,172,981. If the kraft black liquor is under certain temperature and pressure conditions, the lignin will precipitate in a heavy liquid form which could simplify the separation system knowing that the heavy liquid lignin stream will have a higher specific gravity than that of the lignin depleted carbonated black liquor stream and will gravity separate. The heavy liquid lignin stream can then be pumped from the bottom of the separation vessel while the lighter lignin depleted phase can be pumped or decanted from the top of the separation vessel. An example liquid lignin recovery method is described in U.S. Pat. Nos. 2,406,867 and 9,260,464. In the process of the present invention, the separated lignin exiting the carbonation system, whether in solid-like or liquid form, is further processed to improve its purification and done so through the addition of an organic solvent, such as butanol, and water. With sufficient amounts of solvent, heat and pressure, the lignin shall remain or transition into a liquid form. From here, the solvent-lignin-water solution is further processed to remove additional amounts of impurities. A large portion of the impurities will separate to the aqueous phase. Processing aids such as, but not limited to, sulfuric and/or acetic acid can be used to assist in removing these impurities from the lignin and ideally into the aqueous phase.

When butanol and water are used as the solvent solution in biomass or biomass byproduct processing, the cellulose within shall remain in solid form and can be recovered by solid/liquid separation methods such as filtration. From there, a liquid solution remains that is generally comprised of two distinct layers, an aqueous layer and an organic layer. These layers can be separated by gravity, centrifugation or membrane filtration. The aqueous layer is comprised of mostly water and the impurities removed from the liquid lignin stream and the organic layer is comprised of mostly butanol and lignin. The aqueous phase can be purified by evaporation or filtration to remove the impurities to allow the water to be reused in the process. The organic layer is then further processed to remove and recover the butanol for reuse while delivering a recovered lignin stream that can be used for multiple end use applications. The solvent is removed from the organic layer by evaporation to leave behind a high quality lignin stream. Carrier resins or reaction components may be added prior to, during or after the solvent removal step to simplify the operation and to ideally produce a lignin based material better suited for its intended use.

When processing biomass or agricultural residue, where organic solvents, such as butanol are used to delignify the biomass, the solvent requires recovery and reuse to minimize the operating costs. If butanol and water are used at sufficient levels under adequate operating temperature and pressure, the biomass becomes partially delignified so that the cellulose, or pulp, can be filtered from the solution leaving behind the mixture of mostly solvent, water and lignin. When appropriate amounts of butanol and water are used, two distinct liquid layers will form, an organic layer, containing mostly lignin and solvent, and an aqueous layer.

The present invention is directed to recovering and purifying lignin more effectively from a wide range of biomass and byproducts that exist in agricultural processing systems. The objective is to reduce capital and operating cost while producing a lignin that is more suitable for its intended use.

### BRIEF DESCRIPTION OF THE DRAWINGS

FIG. 1 is a diagram of a typical kraft pulping operation where a sodium solvent is used to delignify biomass to allow for the recovery of cellulose which is often referred to as pulp.

FIG. 2 is a diagram of a process that can be used to recover lignin from black liquor within a kraft pulping operation.

FIG. 3 is a diagram of an improved method to dry the moisture laden lignin that exits FIG. 2 where a carrier material is used to keep the lignin in a fluid solution that is more cost effectively dried.

FIG. 4 is a diagram of an improved method to recover lignin from black liquor within a kraft pulping operation through the addition of lignin dissolving solvent(s).

FIG. 5 is a diagram of an improved method where the lignin is further conditioned prior to solvent addition.

FIG. 6 is a diagram of an organosolv pulping operation.

FIG. 7 is a diagram of an improved method to remove solvent from the organic layer exiting FIG. 4, FIG. 5, and FIG. 6.

FIG. 8 is a diagram of an improved method where a carrier material is added to aid in keeping the lignin within a fluid-like environment to allow for cost effective solvent recovery.

FIG. 9 is a diagram of an improved method wherein a second solvent separation stage is added.

FIG. 10 is a diagram of an improved method where a carrier material is added (such as nitrile rubber) prior to or during stage 2 solvent recovery.

FIG. 11 is a diagram of an improved method where additional time and/or adjustable shear is added to modify the performance of the final material, such as when producing acrylonitrile butadiene lignin resin, or ABL resin.

FIG. 12 is a diagram of an improved method which includes the addition of pulp or unwashed pulp to produce a composite that includes lignin, a carrier material and pulp. The vented hot melt extruder is used to remove solvent from the pulp and to potentially eliminate the need to recover solvent from pulp in a separate, preceding step.

### DETAILED DESCRIPTION

Disclosed herein is a method to recover lignin from kraft, sulfite and alcohol pulping operations as well as from cellulosic biorefinery processes and/or essentially any plant based material that contains lignin. The recovery process may include a method to convert lignin or the recovered lignin into a usable form that is more suitable for its intended use.

In industrial chemistry, black liquor is the waste product from the kraft pulping process. The Lignin, hemicelluloses and other extractives are chemically removed or partially removed from woody biomass to free the cellulose fibers for separation and recovery. The equivalent waste product material in the sulfite process is usually called brown liquor, but the terms red liquor, thick liquor and sulfite liquor are also used.

Approximately 7 tons of black liquor are produced in the manufacture of one ton of pulp. The black liquor is an aqueous solution of lignin residues, hemicellulose, organics, minerals and the inorganic chemicals used in the process. The black liquor and concentrated black liquor generally comprises approximately of 10% to 50% solids by weight of which about two thirds are organic materials and one third are inorganic chemicals.

The organic matter in the black liquor is made up of water/alkali soluble degradation components from within the wood. As one example lignin is degraded to shorter fragments with various amounts of components including sulphur, whose content can be approximately 1-2%, and sodium, whose content could be at about 6% of the dry solids matter. Cellulose and hemicellulose is degraded to aliphatic carboxylic acid soaps and hemicellulose fragments. The extractives can include tall oil soap and/or crude turpentine. The soaps can contain about 20% sodium. Typically the residual lignin components serve for hydrolytic or pyrolytic conversion or incineration.

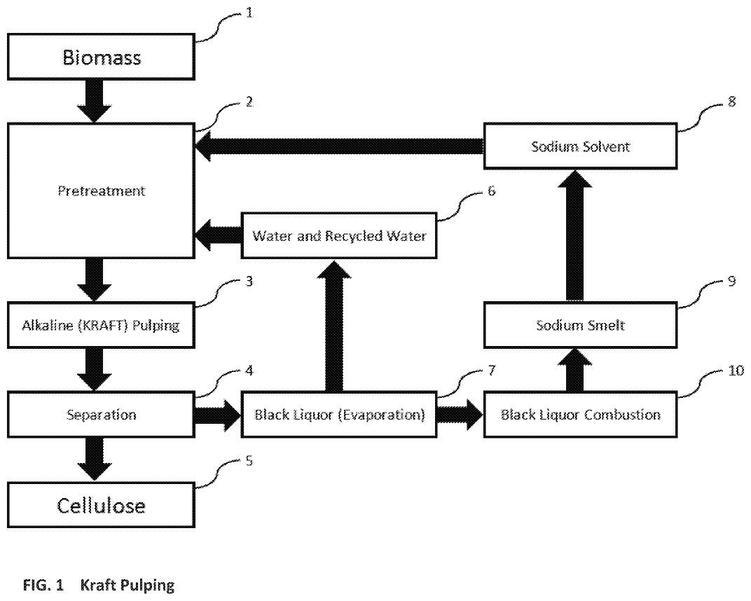

FIG. 1 is a diagram of a typical kraft pulping operation where a sodium solvent is used to delignify biomass to allow for the recovery of cellulose which is often referred to as pulp. Biomass 1 is treated in pre-treatment 2, alkaline (Kraft) pulping 3, separation 4 into cellulose 5. From separation 4, black liquor evaporation 7 produces recycled water 6 and black liquor combustion 10. Sodium smelt 9 provides sodium solvent 8. Sodium solvent 8 is used in pre-treatment 2.

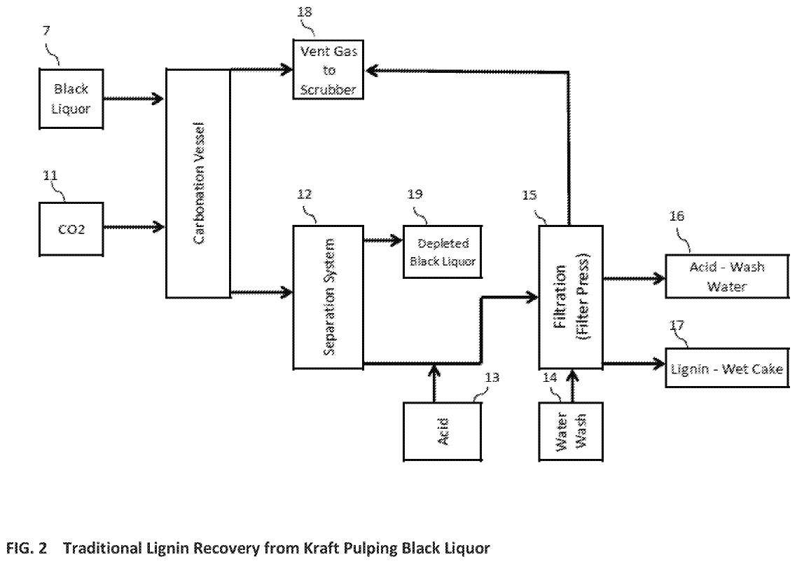

In the case of kraft pulping, a black liquor stream is created that is often concentrated in an evaporator before it is burned in a recovery boiler. As seen in FIG. 2, an acid, such as carbon dioxide (“CO₂”) 11, is added to reduce the pH of black liquor 7 to a level that allows the lignin within to precipitate in carbonation vessel—. Generally, the kraft black liquor exiting pulping digesters is at a PH of between 13 and 14. An acid, such as CO₂, is used to reduce the pH to 12 or less and often less than 11. In most cases the PH is reduced to between 9 to 11. The pH reduction process can be completed in a series of steps to isolate lignin corresponding to the pH in which it precipitates. For example, the black liquor may be reduced from say pH 14 to pH 11 and then allow the lignin that has precipitated to be removed and further processed, while the remaining black liquor containing lignin that did not precipitate is then treated with acid, such as CO₂, to reduce its pH again in a subsequent step, in this example, from pH 11 to pH 9.5 where additional lignin is then precipitated and recovered. The pH start point and reduction intervals are not limiting and can occur in several reducing steps from as high as pH 14 to as low as pH 7. While the pH reduction step most commonly occurs with carbon dioxide (referred to as the carbonation step) this disclosure is not intended to be limited to carbon dioxide and can include any acid or combination of acids such as sulfuric, acetic, citric, nitric, hydrochloric, hydrobromic, hydroiodic, perchloric, chloric, formic, benzoic, methanoic, hydrofluoric, nitrous, phosphoric, hydrogen sulfate, sulfurous and oxalic.

The precipitated lignin produced in the carbonation step is removed in a separation system 12. Depleted black liquor 19 is separated by separation system 12. This lignin may require time to age or agglomerate prior to filtration as described in publication US 2008/0214796 whose entire content shall be included by reference in this disclosure. Next the precipitated lignin is separated to produce a lignin cake and a separate depleted black liquor stream that can be returned to the pulp mill. At this point the lignin is in a concentrated form that, on a dry matter basis, often contains less than 50% non-lignin materials and generally less than 30% of non-lignin impurities. These remaining impurities limit the usefulness of the lignin and a second purification step is often needed. This second purification step is often accomplished through the use of acid treatment 13. Here water and acid are added to free additional impurities from the lignin. The water-acid wash can be applied while the lignin remains on the filter press or it can be added after the lignin cake has been removed from the filter press requiring yet another filtration step to remove the acid washed lignin from the solution. This acid treatment step may use acid wash water with a pH of less than 7, less than 6, less than 5, less than 4, less than 3, or less than a pH of 2. Most often the wash water pH is between 1 and 3 to achieve lignin purities of greater than 95% on a dry matter basis.

Another lignin recovery option would be as described in publication US 2011/0294991 A1 whose entire content be fully incorporated by reference into this disclosure. In this process, the black liquor is at a temperature and pressure that allows the lignin to be precipitated in liquid form in filtration 15 with water wash 14. When under these conditions the liquid lignin is able to separate by gravity in a settling vessel, hydrocyclone or centrifugation. Likewise, after separating the liquid lignin stream a second acid-wash 16 is applied in acid treatment to wash additional impurities from the lignin. In the case of this liquid lignin stream, addition of acid will precipitate the lignin into a solid form where the precipitated solids are then filtered for recovery. Gas from filtration 15 and carbonation vessel—is vented to scrubber 18.

In either above-described method, after the second acid addition, the precipitated lignin is a solid form. This recovered lignin can be further water washed or neutralized to improve its properties for further use. The lignin is finally recovered through liquid-solid separation through the use of a centrifuge or filtration.

A major and costly issue with the prior art lignin recovery processes is the need to produce a dried lignin product from the resulting lignin wet cake 17. The lignin wet cake 17, generally has more than 20% moisture within and often more than 30%. Techniques used to dry this lignin have high manufacturing costs and are very dangerous as the lignin particles are very small and highly susceptible to dust explosions. In some case water is added so that the material can be pumped into a spray dryer further reducing drying efficiency and in other cases the wet cake is dried in other drying systems such as fluid bed and drum drying systems. In all of these cases, the moisture is removed in a low efficiency system requiring more than 973 BTU's to remove each pound of water. In addition, these systems are very dangerous due to the high energy dust-like, explosion prone, lignin particles that are produced requiring careful handling and additional safety precautions. Furthermore, drying lignin often creates irreversible cross-linking of the lignin molecules which often limits the lignins usefulness in downstream applications.

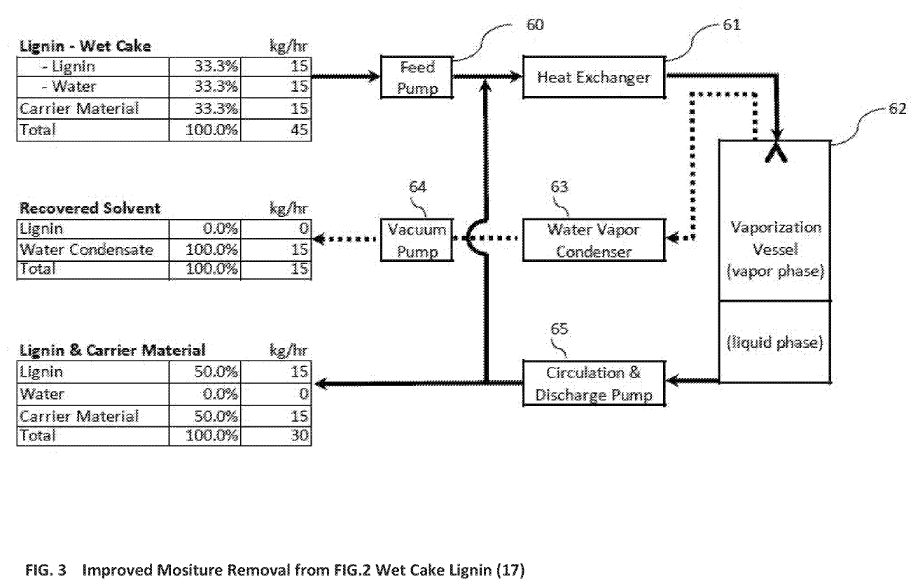

In this embodiment, the acid washed lignin wet cake 17 can be dried through the addition of a carrier material as shown in FIG. 3 that has a vapor pressure lower than water such that the carrier material and lignin can be heated to allow the lignin to remain in a fluid-like environment as it is heated to a temperature and appropriate pressure that allows the water to vaporize and be separated. Wet lignin cake 17 is feed by feed pump 60 to heat exchanger 61. Vaporization vessel 62 separates vapor phase to water vapor condenser 63 and liquid phase to circulation and discharge pump 65. Vacuum pump 64 recovers solvent. In this environment, the dried lignin would not be in a powder form and more safely dried. With an appropriate carrier material present, the material could be extruded into pellets or other form that is less dusty and less prone to explosion. Another carrier material could be a liquid having a vapor pressure lower than water that allows the lignin to be suspended or dissolved into the liquid carrier where the mixture can be dried or partially dried in an evaporator system or multiple effect evaporator system. In some cases, the lignin and its carrier material will exit at the desired reduced moisture level and not require any additional drying. In cases where thermoplastic-like materials are added as a carrier material, such as polyethylene or polypropylene, the resulting material can be extruded and pelletized into yet another safer and more usable form for storage and transportation. Furthermore, the system can be designed as a multiple-effect evaporation system to allow the moisture to be driven out more efficiently when using low viscosity carrier materials. Examples of carrier materials are, but not limited to, vegetable oils, mineral oils, fatty acids, butanol, petroleum derived liquids such as crude oil and diesel, or polymeric materials such as nitrile rubber, polyethylene, polyethylene oxide, polypropylene, glycerol, phenol, and/or additives descried within the additive portions of this document. The most ideal carrier materials are those that would be used in downstream processing systems. For example, if nitrile rubber is used, the dried output could be in the form of a high performance polymer blend material containing a lignin component and an acrylonitrile-containing copolymer as described in U.S. patent application Ser. No. 14/798,729. If phenol is used as a carrier material, the material could, for example, be further processed with formaldehyde to produce a phenol formaldehyde replacement resin. FIG. 3 shows a carrier material used in equal mass to that of the lignin content however the ratio of lignin to the carrier material is not limited to this ratio and shall be whatever is necessary to achieve the desired result.

In addition, various carriers and carrier materials can be used to improve processing of lignin separation and drying, while a second or third carrier material can be integrated into the liquid or solubilized lignin state including, but not limited to plasticizers, functional additives, reactive agents, crosslinkers, fibers, reinforcements, colorants, or blends thereof.

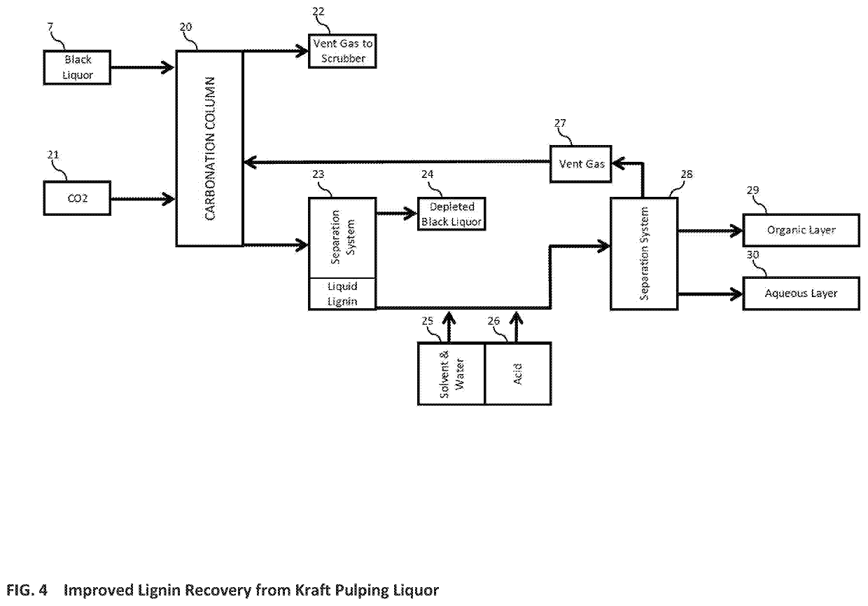

An improved method to recover lignin from kraft pulping operations is shown in FIG. 4. Carbonation column 20 receives black liquor 7 and carbon dioxide 21. Gas 22 from carbonation column 20 is vented to a scrubber. A lignin solvent is added to the concentrated lignin stream exiting the first separation system 23. By doing so, the lignin can become liquefied or remain in liquid form and then be further purified in liquid form as opposed to the solid form during the acid wash step. The lignin solvent can be comprised of a water insoluble, non-polar or hydrophobic solvent. In another embodiment, the lignin solvent contains n-butanol, methyl butanol or mixtures thereof. The pressure shall be equal to or greater than the vapor pressure of water and the lignin solvent mixture to prevent control vaporization of the liquids and at a temperature of between 50° C. and 130° C., or between 120° C. and 150° C., or between 140° C. and 180° C., or between 170° C. and 200° C., or between 190° C. and 210° C. or between 200° C. and 250° C. or between 240° C. and 350° C. In another embodiment, the lignin solvent has a density less than water at ambient temperature. The lignin solvent can be mixed with water, an acid, and/or a lignin dissolving chemical comprising of one of an organic ester, butyl acetate, an organic furan, and furfural. Depleted black liquor is removed by first separation system 23. Solvent and water 25 and acid 26 can be added to assist in freeing impurities from the lignin to produce a purer lignin product. Sufficient volumes of lignin solvent can be added to allow the lignin solvent and lignin density to be less than that of water at ambient temperature. After the solvent, water and acid have been added, vent gases 27 produced are then allowed to safely exit to be scrubbed to meet emission standards while the liquid portion then is separated in second separation system 28 into two liquid phases, an organic layer 29 and an aqueous layer 30. The separation technique for organic layer 29 and aqueous layer 30 can be by gravity, centrifugation, a hydrocyclone or combinations thereof. The organic layer is comprised mostly of lignin solvent and lignin. The vent gas scrubber system can include injecting the gas into the carbonation column to allow any carbon dioxide gases produced from acid 26 addition to then be consumed in the carbonation step thereby reducing carbonation operating cost.

In another embodiment, black liquor 7 is first oxidized to remove odor components and to reduce or eliminate the production of harmful gases such as hydrogen sulfide.

In another embodiment, the lignin solvent is comprised of a water insoluble, non-polar or hydrophobic solvent. In another embodiment the lignin solvent is or contains n-butanol, methyl butenol or mixtures thereof. In another embodiment, the lignin solvent has a density less than water. The lignin solvent can include water, an acid, and/or a lignin dissolving chemical comprising of one of an organic ester, butyl acetate, an organic furan, and furfural. The acid could be comprised of a portion of citric acid, sulfuric acid, acetic acid or combinations thereof. The pH of the solution after lignin-solvent/water/acid addition may be less than 10, less than 9, less than 8, less than 7, less than 6, less than 5, less than 4 or less than 3 and often dependent on the quality of the resulting lignin desired. In another embodiment, the lignin solvent contains lignin.

In another embodiment, the lignin mass percentage after solvent addition FIG. 4 (25) is less than 75%, less than 50%, less than 40%, less than 30%, and most often less than 20% or less than 10% of the mass of the solvent added. The lignin mass percentage after water addition FIG. 4 (25) is greater than 75%, greater than 50%, greater than 40%, greater than 30%, greater than 20%, greater than 10%, or greater than 1% of the mass of any water added to the system.

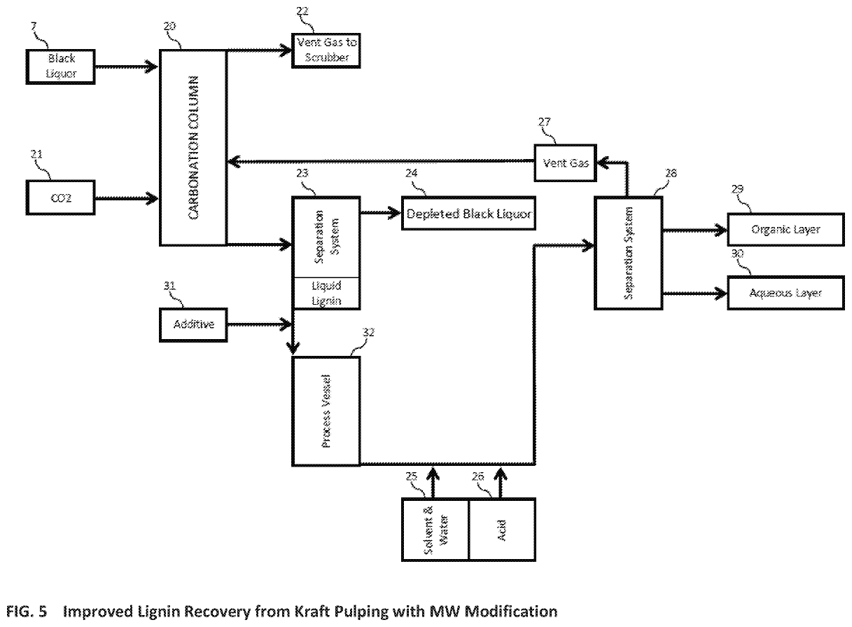

FIG. 5 comprises an additional step that may be introduced to that of FIG. 4 where an additive 31 can be introduced as well as an additional processing vessel 32. In the event that increasing the molecular weight of the lignin is desired, as published in ACS Sustainable Chem. Eng. 2015, 3, pages 1032-1038, by Velez and Thies, the lignin's molecular weight can be increased by allowing the liquid lignin phase to be held for an extended time in this phase. Results indicate that by controlling the retention time of the liquid lignin phase and temperature that the molecular weight can be changed. As a result, the steps described by Valez and Thies are incorporated into this invention disclosure.

In another embodiment, an additive may be added to promote maintaining or reducing the molecular weight of lignin. In this example, a strong base, such as sodium hydroxide, can be added to additive 31 to raise the pH and catalyze lowering of the average molecular weight as described in, but not limited to, US Patent publication number US 2016/0017541 A1. The art described by US 2016/0017541 A1 is fully incorporated by reference into this invention disclosure.

In another embodiment, the carbonation column may reduce the pH of the incoming black liquor in a series of two or more steps to allow various molecular weight lignins to be recovered. Generally speaking, the lignins that first precipitate at the higher pH levels are of higher molecular weight than those that require even lower pH for precipitation. This embodiment includes the use of more than one lignin recovery system of FIG. 2, FIG. 4 or FIG. 5 in series to allow lignin to be recovered in varying molecular weight. For example, the first system may reduce the pH to 11 and recover the lignin that has precipitated at that pH and then the depleted black liquor 19 or depleted black liquor 24 can then be processed in an additional carbonation system that reduces its pH further to recover additional, lower average molecular weight lignin.

In another embodiment, the carbonation column can reduce the pH of the incoming black liquor in a series of two or more steps to allow various molecular weight lignins to be recovered. Generally speaking, the lignins that first precipitate at the higher pH levels are of higher molecular weight than those that require even lower pH for precipitation. This embodiment includes the use of more than one lignin recovery system of FIG. 2, FIG. 4 or FIG. 5 in series to allow lignin to be recovered in varying molecular weight. For example, the first system may reduce the pH to 11 and recover the lignin that has precipitated at that pH and then the depleted black liquor 19 or depleted black liquor 24 may then be processed in an additional carbonation system that reduces its pH further to recover additional, lower average molecular weight lignin.

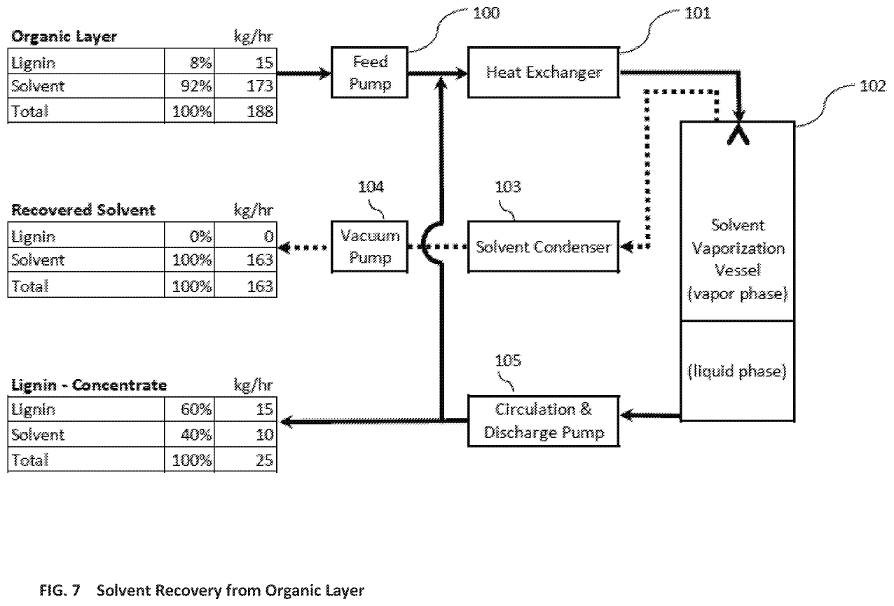

A primary inventive step in FIG. 4 and FIG. 5 is the creation of an organic layer 29 that contains lignin and lignin solvent. Preceding kraft lignin recovery methods have targeted the recovery of a moisture laden lignin cake that often is recovered through the use of a filter press. Filtration systems can be costly and often create additional emission points that require venting and scrubbing. The use of lignin solvents allow the lignin to be recovered in a liquid organic layer which lends itself to alternate further processing and recover methods such as those shown and described in FIGS. 7, 8, 9, 10, 11, and 12. Furthermore, the use of organic solvents allow another method to reduce impurities in the lignin at a higher pH than what was achievable without the use of organic solvents. In some applications, lignin processed in highly acidic environments will damage the quality of the lignin. The solvent can allow impurities to be removed at higher pH levels and therefore provide a less acidic environment and an improved lignin quality is produced.

In another embodiment, an oxidizing step is included to reduce or eliminate some of the odor and/or reduce the amount of hydrogen sulfide reaction vapors. The oxidizing step can occur on the black liquor stream 7 prior to the carbonation column.

In the process of FIG. 4, black liquor 7 from a kraft pulp mill is used at a moisture content of between 10% and 90%, or more ideally between 40% and 75%. The black liquor may be oxidized prior to the carbonization step. This oxidation step can include injection of oxygen containing materials such as, but not limited to, oxygen, air, and/or hydrogen peroxide. The black liquor or oxidized black liquor may be degassed prior to entering the carbonization step. The black liquor can be filtered prior to entering carbonization step to remove solid particles. The black liquor may be subjected to tall oil or soap separation prior to the carbonization step.

Next, the black liquor 7 enters the carbonization column 20 where it is carbonized with carbon dioxide to reduce the pH to below 12, below 11, below 10, or below 9.5. Lignin will precipitate from the solution and can be recovered by filtration to produce a lignin cake that contains a higher percentage of lignin than the black liquor entering the carbonation system.

In another embodiment, referring to FIG. 4 the black liquor 7 is then heated to a temperature of 80° C. to 250° C., or between 80° C. to 180° C. and at a pressure equal to or greater than the pressure required to prevent the moisture within from vaporizing, or boiling at this temperature. The pressure is often be greater than this vapor pressure and can be but not limited to 10 to 100 psig above this vapor pressure, 10 to 75 psig above this vapor pressure, 10 to 50 psig above this vapor pressure or greater than 90 psig and less than 250 psig above this vapor pressure. The carbonation step in carbonation column 20 on this heated and pressurized fluid can produce a precipitated lignin stream that is in liquid form. This concentrated heavy phase liquid lignin precipitate has a high enough specific gravity to allow it to settle into a dense phase concentrated lignin stream that can be removed by decanting or pumping it from the bottom of the vessel. The temperature and pressure may vary with the quality of the black liquor and lignin within to achieve this heavy phase liquid lignin. The preferred carbonation column 20 configuration is in a vertical configuration but can be completed in a horizontal or angular configuration so long as the liquid lignin phase is able to flow to a lower collection point. The column or vessel may be filled with packing to assist in mixing and dispersion of carbon dioxide and/or to assist in the coalescing effect of the liquid lignin particles to allow them to migrate together and form a heavy dense liquid lignin phase. The carbonation column vent gases will then be piped to a vent gas scrubber capable of removing odors and harmful gases such as hydrogen sulfide.

The dense liquid lignin phase can be separated in a separation from the carbonated black liquor stream in a separation system 23 that could include by settling, centrifugation, hydro-cyclones or combinations thereof.

The concentrated lignin stream from separation system 23 is then subjected to additional purification step to remove impurities such as sodium through a secondary treatment step that includes the addition of a lignin solvent, such as an alcohol, butanol, water, acid or combinations thereof. The objective is to get the lignin in liquid or soluble and a lignin solvent, such as butanol, can accomplish this task. The temperature and pressure can remain the same as within the carbonation system but more ideally to a temperature of between 100° C. and 250° C., or between 150° C. and 250° C., or more ideally to a temperature between 170° C. and 220° C. for a time sufficient to allow the lignin to solubilize into the solvent and at a pressure sufficient to prevent and/or control the vaporization of any components within. This solvent addition step shall ideally occur before additional acids are introduced.

After introducing the lignin solvent and water 25 to the concentrated lignin stream or liquid lignin concentrate an acid 26 can be introduced to assist in washing impurities from the lignin within. The acid could be sulfuric, acetic, citric, nitric, hydrochloric, hydrobromic, hydroiodic, perchloric, chloric, formic, benzoic, methanoic, hydrofluoric, nitrous, phosphoric, hydrogen sulfate, sulfurous or oxalic acid or any combinations thereof. The mixture is then allowed to gravity separate into an organic layer 29 and an aqueous layer 30. The organic layer contains mostly lignin solvent and lignin. The aqueous layer mostly contains water and impurities such as sodium creating a brine solution. The organic layer may be subjected to additional water washing steps that may include the addition of water and acid to assist in purifying the lignin. Acetic acid has been shown to provide exceptional purification of lignin and may be used.

In another embodiment, the pressure of the mixture prior to acid 26 addition is sufficiently greater than the maximum pressure in the carbonation system. By operating at this pressure, any gases produced due to the addition of this acid, such as CO₂, can be vented into the carbonation system. If CO₂ is produced from the acid addition step, this CO₂ gas can be introduced to the carbonation step to reduce the CO₂ volume otherwise required by this carbonation step and reduce operating cost. Furthermore, any gases within the mixture would be allowed to pass through the carbonation system and into one common gas scrubbing system to provide a single emission point for process.

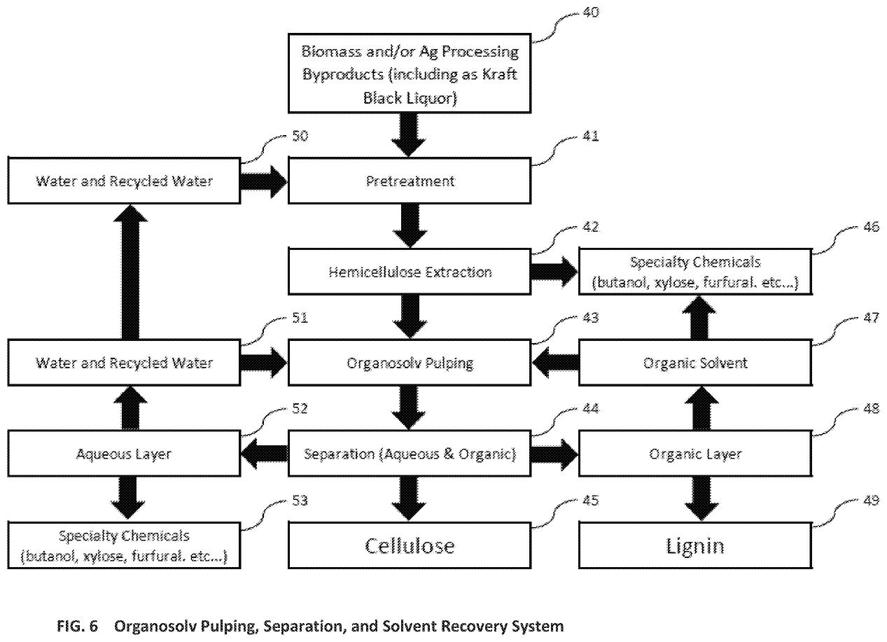

FIG. 6 represents an alternate pulping method that is often referred to as organosolv pulping. In this process, lignin, or a portion thereof, is removed, separated and/or further processed from any form of biomass or agricultural residue, agricultural byproduct, or any plant based product to include, but not limited to wood biomass, algae, crop residue, kraft black liquor, recovered kraft lignin, lignosulfonate and cellulosic biorefinery byproducts such as lignin energy pellets through the use of lignin dissolving solvents. In one embodiment, the lignin solvent is comprised of a water insoluble, non-polar or hydrophobic solvent. In another embodiment, the lignin solvent contains n-butanol, methyl butenol or mixtures thereof. In another embodiment, the lignin solvent is organic. In another embodiment, the lignin solvent contains lignin. In another embodiment the lignin solvent is or contains a portion of any alcohol to include but not be limited to ethanol, methanol, n-butanol, isobutanol, glycerol, or mixtures thereof. In another embodiment, the lignin solvent is or contains a fatty acid to include but not be limited to tall oil fatty acid, vegetable oil fatty acid, animal fat fatty acid, or mixtures thereof. In another embodiment, the lignin solvent is or contains a petroleum distillate. In another embodiment, the lignin solvent has a density less than water. The lignin solvent can also include water, an acid, and/or a lignin dissolving chemical comprising of one of an organic ester, butyl acetate, an organic furan, and furfural. The acid could be comprised of sulfuric, acetic, citric, nitric, hydrochloric, hydrobromic, hydroiodic, perchloric, chloric, formic, benzoic, methanoic, hydrofluoric, nitrous, phosphoric, hydrogen sulfate, sulfurous or oxalic acid or any combinations thereof.

The lignin solvent solubilizes a portion of the lignin in biomass to allow the cellulose to be removed or more easily separated. The addition of heat and pressure generally increases the rate and amount of lignin removal. The longer the period of time the lignin solvent is in contact with the biomass also generally increases the amount of lignin that becomes soluble in the lignin solvent. Biomass and/or by products 40 is subject to pre-treatment 41. Hemicellulose, or a portion thereof, can be optionally removed in hemicellulose extraction 42 prior to the addition of the lignin solvent. The hemicellulose can be converted into specialty chemicals 46 directly or indirectly as a reduce of extraction from the organic solvent phase 47. Oganosolv pumping 43 is performed with organic solvent 47 and water 51. After separation of the pulp 45, sometimes referred to as cellulose, the resulting pulping liquid stream is recycled and reused. The resulting pulping liquid stream is subjected to a separation system 44 where an aqueous stream 52 and an organic layer 48 is produced and lignin 49. Water and recycled water 50 can be provided to pre-treatment 41. Aqueous stream 52 can be treated with specialty chemicals 53. The aqueous layer is further processed cleaned and reused and the organic layer is also further processed to recover lignin and solvent so that much of the solvent can be used.

In another embodiment, water and/or a lignin solvent is added to kraft lignin or any lignin containing material to include but is not be limited to cellulosic biorefinery lignin residuals, as means to further process the lignin.

In another embodiment, water and/or lignin solvent is added to a plant based material to include but not be limited to biomass, agricultural byproducts, a pure or semi-pure form of lignin, kraft lignin, cellulosic lignin residuals or mixtures thereof. The solution may then be heated to improve the recovery and separation of lignin and/or the treatment or conversion of lignin into a different form or quality such as a biofuel or biofuel feedstock. In one embodiment the solution maybe heated to a temperature: greater than 20° C. and less than 400° C., greater than 50° C. and less than 250° C., greater than 100° C. and less than 250° C., greater than 100° C. and less than 225° C., greater than 100° C. and less than 200° C., greater than 150° C. and less than 250° C., greater than 150° C. and less than 225° C., greater than 150° C. and less than 200° C., or greater than 100° C. and less than 180° C. The reactor pressure shall be equal or greater than the vapor pressure of the lignin solvent at the process operating temperature to prevent boiling or control the vaporization of the solvent and water. At any given operating temperature, the operating pressure can be equal to the corresponding solvent vapor pressure, between 0 psig and 50 psig above the solvent vapor pressure, between 15 psig and 75 psig above the solvent vapor pressure, between 50 psig and 100 psig above the solvent vapor pressure, between 75 psig and 250 psig above the solvent vapor pressure, between 150 and 450 psig above the solvent vapor pressure, or between 300 and 600 psig above the solvent vapor pressure, or between 500 and 2000 psig above the solvent vapor pressure at the given operating temperature. The process can be operated in a batch, continuous or semi-continuous manner.

In another embodiment, a liquid-solid separation system is used to remove a portion of the liquids from the solids or digested solids. The liquid-solid separation system can include, but not be limited to: a centrifuge, a screen, a rotary screen, a screw press, a solids-liquid filtration system, a vacuum drum filter, a membrane filtration system, a belt press, a liquids evaporation system, decanting system or other known liquid-solids separation system. The liquid-solid separation system may only separate a portion of the solids and may have carryover or significant carryover of liquids in the separated solids stream or solids in the separated liquids stream.

In another embodiment, the separated liquids stream may be further processed to separate additional solids. The further processing system may include the use of a centrifuge, decanting system, membrane filtration system, filtration system or other means to remove solids.

In another embodiment, the separated liquids stream or mostly liquids stream separated from the solids may be further processed to include a liquid-liquid separation system. The liquid-liquid separation system may include density separation, gravity separation, decanting, centrifugal separation, chemical separation, evaporation, distillation, membrane separation or other recognized liquid-liquid separation method.

In another embodiment, the separated liquids stream is divided into two primary streams. One stream may be of lower density than the other. One stream may primarily consists of water and the other stream may primarily consists of organic solvent where the organic solvent can be comprised of one or more of: an alcohol, n-butanol, isobutanol, butyl acetate, lignin and/or furfural. The organic solvent containing lignin stream is referred to as the organic layer in this disclosure.

In another embodiment the organic layer stream is further processed.

In another embodiment the organic layer is further processed in an evaporation system or distillation system to remove a portion of the organic solvents to produce a more concentrated form of lignin within the organic layer.

In another embodiment, the organic layer, concentrated organic layer, organic solvent containing lignin stream and/or concentrated form of lignin and solvent stream are heated to temperature and pressure sufficient to produce a sub-critical, near critical or super critical condition that converts a portion of the lignin and/or lignin solvent into a fuel or biofuel or more usable feedstock to produce fuel or biofuel. This is may be more ideally suited when purer forms of lignin or a semi-pure lignin is used as the feedstock. The embodiment can be operated in a batch, continuous or semi-continuous manner. The resulting fuel or biofuel can be further processed to produce alternate forms of fuel or biofuel. These further processing methods can include but are not limited to hydrotreating, hydrothermal processing, pyrolysis, and Fischer Tropsch.

In another embodiment a semi-pure lignin feedstock is defined on a water free basis as having less than 50% non-lignin materials within, less than 30% non-lignin materials within, less than 15% non-lignin materials within, less than 10% non-lignin materials within, less than 6% non-lignin materials within, less than 3% non-lignin materials within, less than 2% non-lignin materials within, less than 1% non-lignin materials within, less than 0.5% non-lignin materials within, less than 0.2% non-lignin materials within, less than 0.1% non-lignin materials within but greater than 0% of non-lignin materials.

In another embodiment, water and/or a carrier material that may or may not contain lignin solvents is added to a plant based material to include but not be limited to a pure or semi-pure form of lignin, kraft lignin, cellulosic lignin residuals or mixtures thereof. The solution may then be heated to improve the recovery and separation of lignin and/or the treatment or conversion of lignin into a different form or quality such as a biofuel or biofuel feedstock. In one embodiment the solution maybe heated to a temperature greater than 20° C. and less than 400° C., greater than 50° C. and less than 250° C., greater than 100° C. and less than 250° C., greater than 100° C. and less than 225° C., greater than 100° C. and less than 200° C., greater than 150° C. and less than 250° C., greater than 150° C. and less than 225° C., greater than 150° C. and less than 200° C., or greater than 100° C. and less than 180° C. The reactor pressure shall be equal or greater than the vapor pressure of a materials within the vessel at the process operating temperature to prevent boiling or control the vaporization of any materials within. At any given operating temperature, the operating pressure shall not be greater than 2000 psig above, not be greater than 1000 psig above, not be greater than 500 psig above, not be greater than 300 psig above, not be greater than 200 psig above, not be greater than 100 psig above, or not than 50 psig above the minimum pressure to prevent vaporization of any materials within the process. The process can be operated in a batch, continuous or semi-continuous manner. In another embodiment, pressure and temperature are sufficient to produce a near critical or super critical condition that converts the lignin and/or lignin carrier material into a fuel. This is more ideally suited when pure lignin or a semi-pure lignin is used as the feedstock. The resulting fuel can be further processed to produce alternate forms of fuel. These further processing methods can include but are not limited to hydrotreating, hydrothermal processing, pyrolysis, and Fischer Tropsch. In another embodiment a semi-pure lignin feedstock on a water free basis has less than 50% non-lignin materials within, less than 30% non-lignin materials within, less than 15% non-lignin materials within, less than 10% non-lignin materials within, less than 6% non-lignin materials within, less than 3% non-lignin materials within, less than 2% non-lignin materials within, less than 1% non-lignin materials within, less than 0.5% non-lignin materials within, less than 0.2% non-lignin materials within, less than 0.1% non-lignin materials within but greater than 0% of non-lignin materials.

This invention describes an improved method to process the organic layer 29 produced from kraft, alkaline, soda or sulfate pulping operations as well as the organic layer 48 produced from organosolv pulping operations as shown in FIG. 6 as the processing techniques can be applied to the organic layer produced from either pulping operation. The organic layer may include inorganic impurities.

In one embodiment shown in FIG. 7, a portion of the lignin solvents are removed from the organic layer through a solvent evaporation system to form a lignin solvent concentrate. In this system, the organic layer is pumped by pump 100 to be heated in heat exchanger 101 to allow the solvent vaporize, be separated in solvent vaporization vessel 102 and condensed in solvent condenser 103. Vacuum pump 104 recovers solvent. Circulation and discharge pump 105 recovers lignin concentrate. The circulation discharge pump 105 can then discharge the lignin concentrate or return the material through a heat exchanger 106 to the solvent vaporization vessel for additional solvent removal. The solvent vaporization vessel 102 can be under partial vacuum to reduce the operating temperature requirement of the organic layer or the solvent vaporization vessel may be under pressure to increase the operating temperature of the organic layer. The initial organic layer has a solvent to lignin ratio of less than 200:1, less than 100:1, less than 50:1, less than 40:1, less than 30:1, less than 25:1, less than 20:1, less than 15:1, less than 10:1, less than 5:1 or less than 2:1. The final concentrated organic layer will have a lignin solvent content to lignin ratio that is less than less than 10:1, less than 1:1, less than 1:2, less than 1:4, less than 1:5, less than 1:7, less than 1:9, or less than 1:10. FIG. 7 shows an incoming lignin content of 8% and outgoing concentration of 60% as an example however, the inputs and outputs are not limited to these values and they serve only as an example of the lignin becoming concentrated. Furthermore, additional impurities, organic and inorganic, may be present in the organic layer and concentrated lignin-solvent.

In one embodiment, lignin solvents are added to biomass before heating, pulping and/or digestion on a dry matter basis of solvent to biomass at between a 1:1 and a 20:1 ratio, or between a 1:1 and 10:1 ratio, or between a 2:1 and 5:1 ratio, or between a 2.5:1 and 4:1 ratio. In another embodiment, water is also added to biomass before heating, pulping and/or digestion on a dry matter basis of water to biomass at between a 1:1 and a 20:1 ratio, or between a 1:1 and 10:1 ratio, or between a 2:1 and 5:1 ratio, or between a 2.5:1 and 4:1 ratio.

In one embodiment, the solvent vaporization vessel 102 is at a pressure above atmospheric pressure to allow for higher internal temperatures to allow lower liquid phase FIG. 7 (102) viscosities as the solvent to lignin ratios decrease. In another embodiment, the solvent vaporization vessel is at a pressure below atmospheric pressure to allow for lower process temperatures. Solvent recovery under vacuum is commonly practices when possible. In another embodiment, the solvent condenser (103) could be used as an inter-changer to pre-heat the incoming organic layer or used to heat the organic layer in a multiple effect evaporation system. In another embodiment, a multiple effect solvent vaporization system could be used to improve the efficiency of the solvent recovery system in lieu of the single effect system shown in FIG. 7.

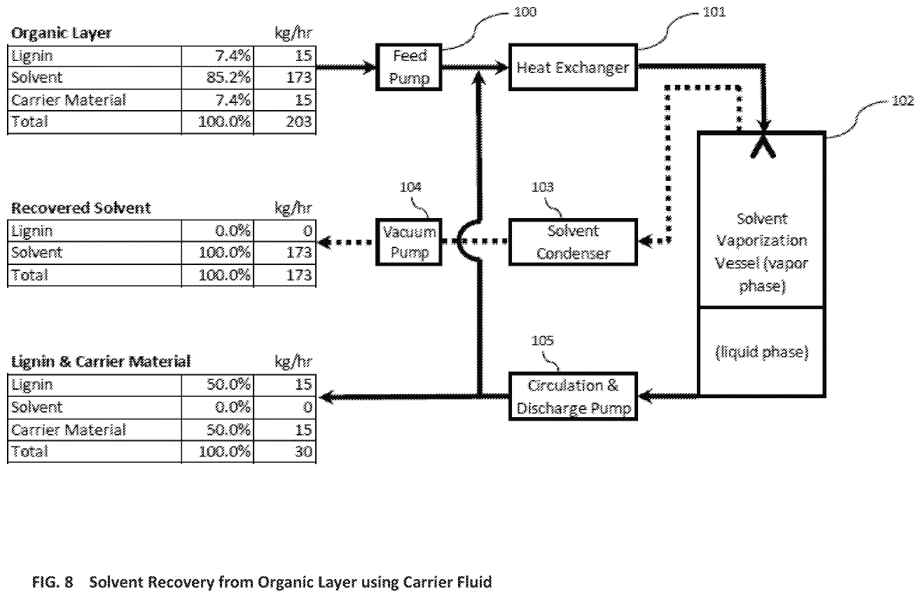

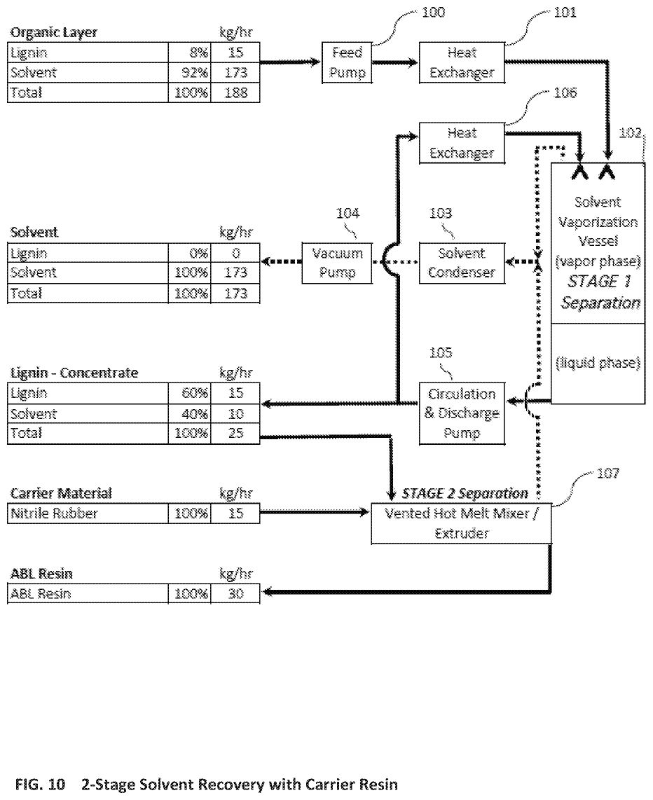

In another embodiment a carrier material is added to the organic layer as seen in FIG. 8 or added to a partially evaporated organic layer as seen in FIG. 10. The values in FIG. 8 and FIG. 10 are for example purposes and not intended to be limiting. The carrier material may be used to improve the processibility of the organic layer and/or may be used to enhance the properties of the resulting materials. The carrier material would often have a vapor pressure lower than many of the lignin solvent(s), such that the carrier material and lignin can be heated to allow the lignin to remain in a fluid-like environment as the mixture is heated to a temperature that allows a portion of the lignin solvent to vaporize and be separated and recovered. Furthermore, the system can be designed in a multiple-effect evaporation system to allow the moisture to be driven out more efficiently. Examples of carrier materials are, and not limited to vegetable oils, mineral oils, fatty acids, butanol, petroleum derived liquids such as crude oil and diesel, or polymeric materials such as nitrile rubber, polyethylene, polyethylene oxide, polypropylene, glycerol, phenol or mixtures thereof. Carrier materials could be those that would be used in downstream applications. For example, if nitrile rubber is used, the dried output could be ABL resin (acrylonitrile, butadiene and lignin), a desirable end material for use in plastics.

In another embodiment, phenol could be used as a carrier material in FIG. 7. It has been demonstrated that treating lignin with organic solvents or a mixture of lignin and phenol with organic solvents, will improve the adhesive performance of adhesives made with the inclusion of lignin to replace a portion of phenol. For example, the phenol-lignin material exiting the solvent recovery system FIG. 8 could be processed with formaldehyde to produce a phenol formaldehyde replacement resin. FIG. 8 shows a carrier material used in equal mass to that of the lignin content however the ratio of lignin to the carrier material is not limited to this ratio and shall be whatever is necessary to achieve the desired result. Furthermore, FIG. 8 also shows a final solvent content of 0% which is for example purposes only as the solvent content could be greater than 0%.

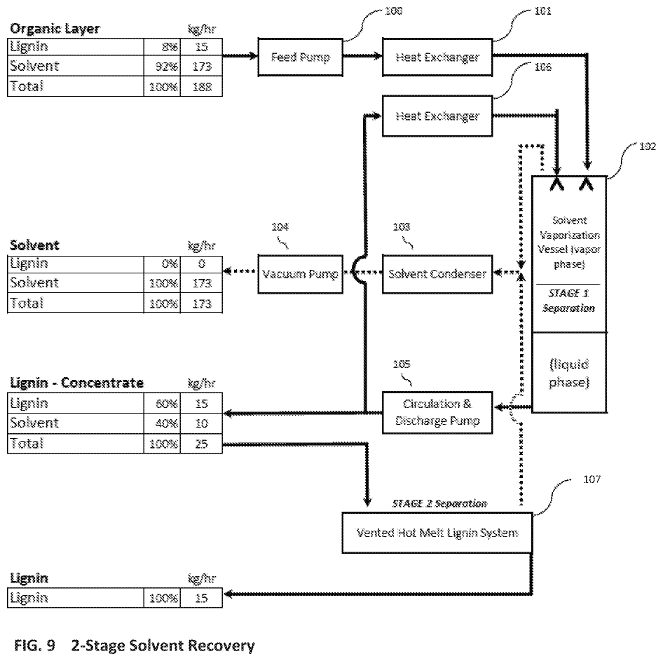

In another embodiment a vented hot melt lignin system 107 is used as a second stage solvent recover step as seen in FIG. 9. This would allow the circulation of the organic layer in a lower viscosity state where most of the solvent is recovered in a single or multiple effect evaporator that is then followed by a second state separation unit that is designed to process higher viscosities as a finishing solvent removal system. This system could be comprised of a hot melt extruder with venting or a hot viscosity pumping and heating system.

In another embodiment, a carrier material, as described previously, is added to the second stage separation system using vented hot melt mixer 107 as shown in FIG. 10.

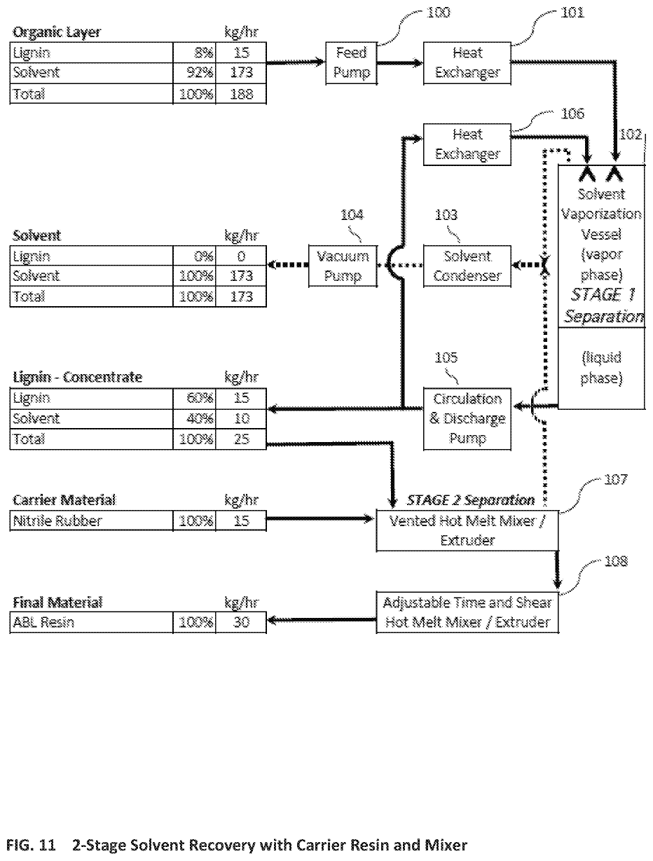

In another embodiment, an adjustable time and shear hot melt mixer/extruder 108 is used in an additional processing step as shown in FIG. 11 to provide enhanced mixing of the lignin and carrier material. In the case of mixing nitrile rubber with lignin, improved performance can be obtained with highly controlled mixing of the nitrile rubber with the lignin. This controlled mixing step can be added to the first stage solvent recovery system or the second stage solvent recovery system.

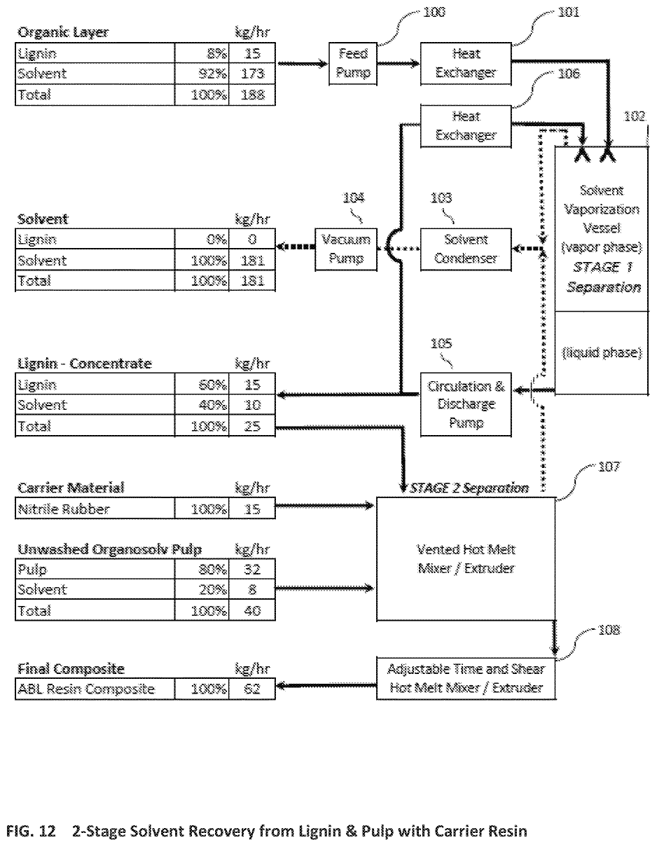

In another embodiment, solvent containing pulp that exist organosolv pulping operations can be added to the melt flowing lignin or to a mixture of lignin and a carrier fluid. Here the second stage separation system would remove solvent from the pulp to produce a composite that is comprised of pulp and lignin or pulp, lignin and a carrier material. While FIG. 12 shows the use of a carrier material, this step is not limited to the use of a carrier material.

In another embodiment, biomass can be washed with acidic water to remove a portion of the hemicellulose wherein the resulting reduced hemicellulose material can be compounded with a resin to produce a composite. The resin can be a thermoplastic resin, a thermoset resin, or nitrile rubber.

In another embodiment, biomass such as hybrid poplar, is processed in an organosolv process to produce a lignin concentrate and a washed or unwashed pulp material. The lignin may be processed with phenol and then with formaldehyde to produce a thermoset resin that is then added to pulp, washed organosolv pump, unwashed organosolv pulp and other fillers or additives to produce a composite that can be used in many applications such as a home siding product or engineered lumber composite.

Within this invention a carrier, or carrier material, second or third component can be blended or reacted with the lignin in its liquid or molten flowable state. The following provides for various carriers, second or third component or blends thereof that can be blended or reacted within the liquid or molten biopolymeric lignin stream of this process.

Plasticizers are, in general, high boiling point liquids with average molecular weights of between 300 and 600, and linear or cyclic carbon chains (14-40 carbons). The low molecular size of a plasticizer allows it to occupy intermolecular spaces between polymer chains, reducing secondary forces among them. In the same way, these molecules change the three-dimensional molecular organization of polymers, reducing the energy required for molecular motion and the formation of hydrogen bonding between the chains. As a consequence, an increase in the free volume and, hence, in the molecular mobility is observed. Thus, the degree of plasticity of polymers is largely dependent on the chemical structure of the plasticizer, including chemical composition, molecular weight and functional groups. A change in the type and level of a plasticizer will affect the properties of the final flexible product. The selection for a specified system is normally based on the compatibility between components; the amount required for plasticization; processing characteristics; desired thermal, electrical and mechanical properties of the end product; permanence; resistance to water, chemicals and solar radiation; toxicity and cost

Within this invention various plasticizers can be blended into the liquid lignin within this process while the lignin is still within a liquid, dissolved or molten state.

The most commonly used plasticizers are polyols, mono-, di- and oligosaccharides. Polyols have been found to be particularly effective for use in plasticized hydrophilic polymers. Glycerol (GLY) was, thus, nearly systematically incorporated in most of the hydrocolloid films. GLY is indeed a highly hygroscopic molecule generally added to film-forming solutions to prevent film brittleness.

Ethylene glycol, sorbitol, fatty acids, hydrogenated fatty acids, hydrogenated triglycerides, waxes, urea, vegetable oils amino acids, bio-succinic acid, di-octyl succinate (DOSX) compared to dioctyl adipate (DOA) and dioctyl phthalate (DOP), succinate esters, citric acids, lactic acids, urea.

Various additional plasticizers that may be used include various esters including, but not limited to citric acid or citrate esters, levulinic acid esters and derivatives, glucose esters, Succinate or Succinic esters, cellulosic esters, cellulose acetate, Polypropanediol (PPD), Polypropanediol benzoate (PPDB), furandicarboxylate esters, acetic acid esters, tributyl citrate, acetyl tributyl citrate, or combinations thereof.

Addition carrier materials include propylene glycol, also called propane-1,2-diol, is a synthetic organic compound with the chemical formula C₃H₈O₂. It is a viscous colorless liquid which is nearly odorless but possesses a faintly sweet taste. Chemically it is classed as a diol and is miscible with a broad range of solvents, including water, acetone, and chloroform.

Various methyl plasticizers or methyl based resins can also be used such as methyl methacrylate and other forms of methyl resins.

Esters of phthalic acid constitute another group of plasticizers for this invention. Most of them are based on carboxylic acid esters with linear or branched aliphatic alcohols of moderate chain lengths (predominantly C₆-C₁₁). In relation to the classic plasticizers, the phthalate esters, adipates, citrates besides acids esters, alkane-dicarboxylic, glycols and phosphates are used. In addition ethylene glycol (EG), diethylene glycol (DEG), triethylene glycol (TEG), tetraethylene glycol and polyethylene glycol (PEG), propylene glycol (PG), sorbitol, mannitol and xylitol, fatty acids, monosaccharides (glucose, mannose, fructose, sucrose), ethanolamine (EA); urea; triethanolamine (TEA); vegetable oils; lecithin; waxes.

Various waxes can be hydrogenated such as hydrogenated soybean oils or sourced from other vegetables oils and used as a carrier material.

In another embodiment, the entire process can be operated in a batch, continuous, semi-continuous manner or combinations thereof.

Various acids can be either a second or third components. Suitable acids include, but not limited to: phosphoric acid, sulfuric acid, various organic acids, citric acids, acetic acid, acid salts, such as aluminum sulfate, water soluble organic acids, formic acid, glycolic acid, propionic acid, butyric acid, valeric acid, lactic acid, benzoic acid or blends thereof. The pH adjustment of the elastic lignin rubber and change both the water resistance and effect the stickiness of the liquid lignin during various processing steps.

Within the liquid or molten lignin state of this process, various rubbers can be added with the carrier or as a potential carrier in either liquid or powder forms to create modified versions of “elastic lignin”. Various rubbers include but not limited to; Natural polyisoprene: cis-1,4-polyisoprene natural rubber (NR) and trans-1,4-polyisoprene gutta-percha, synthetic polyisoprene (IR for isoprene rubber), polybutadiene (BR for butadiene rubber), chloroprene rubber (CR), polychloroprene, neoprene, Baypren etc, butyl rubber (copolymer of isobutylene and isoprene, IIR), halogenate butyl rubbers (chloro butyl rubber: CUR; bromo butyl rubber: BIIR), Styrene-butadiene rubber (copolymer of styrene and butadiene, SBR), Nitrile rubber (copolymer of butadiene and acrylonitrile, NBR), also called Buna N rubber, hydrogenated nitrile rubbers (HNBR) Therban and Zetpol, EPM (ethylene propylene rubber, a copolymer of ethylene and propylene) and EPDM rubber (ethylene propylene diene rubber, a terpolymer of ethylene, propylene and a diene-component), epichlorohydrin rubber (ECO), polyacrylic rubber (ACM, ABR), silicone rubber (SI, Q, VMQ), fluorosilicone rubber (FVMQ), fluoroelastomers (FKM, and FEPM) Viton, Tecnoflon, Fluorel, Aflas and Dai-El, perfluoroelastomers (FFKM) Tecnoflon PFR, Kalrez, Chemraz, Perlast, polyether block amides (PEBA), chlorosulfonated polyethylene (CSM), (Hypalon), ethylene-vinyl acetate (EVA), thermoplastic elastomers (TPE), the proteins resilin and elastin, polysulfide rubber, elastolefin, elastic fiber used in fabric production.

The meltable flowable lignin from this invention can also include as a second or third component a thermoplastic material which can be blended or reacted within the molten lignin state within our process or within a secondary process using a twin screw compounding systems.

Suitable thermoplastics include polyamide, polyolefin (e.g., polyethylene, polypropylene, polyethylene-copropyleno), poly(ethylene-coalphaolefin), polybutene, polyvinyl chloride, acrylate, acetate, and the like), polystyrenes (e.g., polystyrene homopolymers, polystyrene copolymers, polystyrene terpolymers, and styrene acrylonitrile (SAN) polymers), polysulfone, halogenated polymers (e.g., polyvinyl chloride, polyvinylidene chloride, polycarbonate, or the like, copolymers and mixtures of these materials, and the like. Suitable vinyl polymers include those produced by homopolymerization, copolymerization, terpolymerization, and like methods. Suitable homopolymers include polyolefins such as polyethylene, polypropylene, poly-1-butene, etc., polyvinylchloride, polyacrylate, substituted polyacrylate, polymethacrylate, polymethylmethacrylate, copolymers and mixtures of these materials, and the like.

Suitable copolymers of alpha-olefins include ethylene-propylene copolymers, ethylene-hexytene copolymers, ethylene-methacrylate copolymers, ethylene-methacrylate copolymers, copolymers and mixtures of these materials, and the like. In certain embodiments, suitable thermoplastics include polypropylene (PP), polyethylene (PE), and polyvinyl chloride (PVC), copolymers and mixtures of these materials, and the like. In certain embodiments, suitable thermoplastics include polyethylene, polypropylene, polyvinyl chloride (PVC), low density polyethylene (LDPE), copoly-ethylene-vinyl acetate, copolymers and mixtures of these materials, and the like.

Additional plastics include various forms of acrylic such as a Polymethyl Methacrylate (PMMA), Acrylic, Methyl Methacrylate, and other forms of acrylic. The addition of the acrylic can provide additional performance advantages even at small additional levels.

Additional thermoplastic elastomeric materials can be used such as TPE, TPO, nitrile rubber, natural rubber and other similar materials.

Suitable biobased thermoplastic materials include polymers derived from renewable resources, such as polymers including polylactic acid (PLA) and a class of polymers known as polyhydroxyalkanoates (PHA). PHA polymers include polyhydroxybutyrates (PHB), polyhydroxyvalerates (PHV), and polyhydroxybutyrate-hydroxyvalerate copolymers (PHBV), polycaprolactone (PCL) (i.e. TONE), polyesteramides (i.e. BAK), a modified polyethylene terephthalate (PET) (i.e. BIOMAX), and “aliphatic-aromatic” copolymers (i.e. ECOFLEX and EASTAR BIO), mixtures of these materials and the like.

The lignin in its liquid or molten state within this process or during post processing can include a fiber reinforcement or filler. Various fiber reinforcements include cellulosic fiber can be added with the elastic lignin including, but not limited to paper pulp, recycled paper fiber, paper mill sludge, paper mill residue, agricultural fibers, wood flour, wood fiber, synthetic fibers, fiberglass and blends thereof. By adding the fiber, especially hydrophilic cellulosic fiber into the elastic lignin, this allows for processing at lower temperatures protecting the cellulosic, but moreso provides improved impregration of the cellulosic fiber for improved water resistance. Basically we are “reassembling” the tree.

Additional fillers can include minerals. Various minerals include common minerals used in filled plastics.)

The term “flame retardants” subsumes a diverse group of chemicals which are added to manufactured materials, such as plastics and textiles, and surface finishes and coatings. Flame retardants inhibit or delay the spread of fire by suppressing the chemical reactions in the flame or by the formation of a protective layer on the surface of a material. They may be mixed with the base material (additive flame retardants) or chemically bonded to it (reactive flame retardants)[1], Mineral flame retardants are typically additive while organohalogen and organophosphorus compounds can be either reactive or additive.

Both reactive and additive flame retardants types, can be further separated into several different classes:

Minerals such as aluminium hydroxide (ATH), magnesium hydroxide (MDH), huntite and hydromagnesite, various hydrates, red phosphorus, and boron compounds, mostly borates.

Organohalogen compounds. This class includes organochlorines such as chlorendic acid derivatives and chlorinated paraffins; organobromines such as decabromodiphenyl ether (decaBDE), decabromodiphenyl ethane (a replacement for decaBDE), polymeric brominated compounds such as brominated polystyrenes, brominated carbonate oligomers (BCOs), brominated epoxy oligomers (BEOs), tetrabromophthalic anyhydride, tetrabromobisphenol A (TBBPA) and hexabromocyclododecane (HBCD). Most but not all halogenated flame retardants are used in conjunction with a synergist to enhance their efficiency. Antimony trioxide is widely used but other forms of antimony such as the pentoxide and sodium antimonate are also used.

Organophosphorus compounds. This class includes organophosphates such as triphenyl phosphate (TPP), resorcinol bis(diphenylphosphate) (RDP), bisphenol A diphenyl phosphate (BADP), and tricresyl phosphate (TCP); phosphonates such as dimethyl methylphosphonate (DMMP); and phosphinates such as aluminium diethyl phosphinate. In one important class of flame retardants, compounds contain both phosphorus and a halogen. Such compounds include tris (2,3-dibromopropyl) phosphate (brominated tris) and chlorinated organophosphates such as tris (1,3-dichloro-2-propyl) phosphate (chlorinated tris or TDCPP) and tetrakis (2-chlorethyl) dichloroisopentyldiphosphate.

The mineral flame retardants mainly act as additive flame retardants and do not become chemically attached to the surrounding system. Most of the organohalogen and organophosphate compounds also do not react permanently to attach themselves into their surroundings but further work is now underway to graft further chemical groups onto these materials to enable them to become integrated without losing their retardant efficiency. This also will make these materials non emissive into the environment. Certain new non halogenated products, with these reactive and non emissive characteristics have been coming onto the market since 2010, because of the public debate about flame retardant emissions. Some of these new reactive materials have even received US-EPA approval for their low environmental impacts.

Various colorants and methods are included which can change the basic “black” color of the liquid meltable lignin to broaden its applications in various products. Suitable inorganic colorants include metal-based coloring materials, such as ground metal oxide colorants of the type commonly used to color cement and grout. Such inorganic colorants include, but are not limited to: metal oxides such as red iron oxide, yellow iron oxide, titanium dioxide (TiO2), yellow iron oxide/titanium dioxide mixture, nickel oxide, manganese dioxide, and chromium oxide; mixed metal rutile or spinet pigments such as nickel antimony titanium rutile, cobalt aluminate spinel, zinc iron chromite spinel, manganese antimony titanium rutile, iron titanium spinel, chrome antimony titanium ruffle, copper chromite spinel, chrome iron nickel spinel, and manganese ferrite spinel; lead chromate; cobalt phosphate; cobalt lithium phosphate; manganese ammonium pyrophosphate; cobalt magnesium borate; and sodium alumino sulfosilicate.

Suitable organic colorants include, but are not limited to: carbon black such as lampblack pigment dispersion; xanthene dyes; phthalocyanine dyes such as copper phthalocyanine and polychloro copper phthalocyanine; quinacridone pigments including chlorinated quinacridone pigments; dioxazine pigments; anthroquinone dyes; azo dyes such as azo naphthalenedisulfonic acid dyes; copper azo dyes; pyrrolopyrrol pigments; and isoindolinone pigments. Such dyes and pigments are commercially available from Mineral Pigments Corp. (Beltsville, Md.), Shephard Color Co. (Cincinnati, Ohio), Tamms Industries Co. (Itasca, Huls America Inc. (Piscataway, N.J.), Ferro Corp. (Cleveland, Ohio), Engelhard Corp. (Iselin, N.J.), BASF Corp. (Parsippany, N.J.), Ciba-Geigy Corp. (Newport, Del.), and DuPont Chemicals (Wilmington, Del.).

Additional materials and processes can also be used to lighten the color of the liquid lignin material including bleaching, hydrogen peroxide processing, and other methods for brightening lignin.

The present invention can also integrate various crosslinking chemistry to improve various functionality or convert the meltable flowable lignin into more of a thermoset state. Various cross linkers and modifiers can be added within the elastic lignin process and product at elevated temperatures during kneading. Suitable for this purpose are aldehydes, formaldehyde, aniline, melamine, diisocynates, urea, peroxides, and other common cross linking types of additives. Additional cross linkers also include various organic acids such as citric acid, citric acid ester, acetic acid and other organic ester based material.

The invention also includes the ability to integrate Electron Beam exposure which can either lower or increase molecular weight.

The meltable flowable lignin from this invention also can provide for a modified lignin that can be used for carbon fiber precursors and carbon fiber products. The invention includes integration of this lignin with various polymers used in the production of carbon fiber including, but not limited to polyacrylonitrile.

Polyacrylonitrile (PAN), also known as Creslan 61, is a synthetic, semicrystalline organic polymer resin, with the linear formula (C₃H₃N)ₙ. Though it is thermoplastic, it does not melt under normal conditions. It degrades before melting. It melts above 300° C. if the heating rates are 50° per minute or above.[1] Almost all polyacrylonitrile resins are copolymers made from mixtures of monomers with acrylonitrile as the main component. It is a versatile polymer used to produce large variety of products including ultra filtration membranes, hollow fibers for reverse osmosis, fibers for textiles, oxidized PAN fibers. PAN fibers are the chemical precursor of high-quality carbon fiber. PAN is first thermally oxidized in air at 230° Celsius to form an oxidized PAN fiber and then carbonized above 1000° Celsius in inert atmosphere to make carbon fibers found in a variety of both high-tech and common daily applications

With the process of extracting a liquid meltable flowable lignin, the lignin is dissolved within an organic alcohol in an acid environment. Once the organic alcohol is fully removed the lignin typically is in a solid form ranging from black brittle material to a bioelastomeric rubber based on the addition of a carrier, second or third component. If a portion of the alcohol remains within the lignin from about 10-40%, the lignin is in the form of a natural rubber like material depending on a specific temperature. The invention also includes the addition of various additives listed about that are “kneaded” into the bioelastic lignin in this condition. This provides for new processing methods to create various bioenhanced rubbers, plastics and hot melt adhesive system.

In the following, the invention will be described in detail by way of Examples. The invention, however, should not be limited in any way.

### Examples

Example 1—Powdered kraft lignin purchased from a paper mill was heated in a pan to attempt to melt the lignin. The lignin smoked significantly with a very bad smell at temperatures over 200° F. and simply burnt at higher temperatures.

A second test was done with Melting experiments were carried out using MelTemp II (Laboratory Devices, Inc.) apparatus and open Pyrex capillary tubes (0.8-1.1×90 mm) filled with 5 mm fine ground lignin. Kraft lignin gradually darkens with no pronounced phase transformations and then turns into dark carbon-like matter. It is significantly carbonized after 250° C.

Example 2—The powdered lignin was mixed with wax and oils at levels from 10% to 50%. The mixed materials remained in liquid form even at elevated temperatures over 250° F. At higher temperatures above 275° F., the admixture degraded and boiled. After cooling the lignin admixture was extremely brittle and burnt.

Example 3—The powdered lignin was mixed with 30% isopropyl alcohol and stirred for 2 minutes. The mixture was liquid. The mixture was then kneaded and allow the alcohol level to drop by evaporation. To our surprise the mass became doughy, then with further kneading, lost its stickiness and became rubbery. The elastic rubbery mass was then allowed to sit overnight, but again to our surprise was still rubbery even though we expected the alcohol to evaporate over night. The rubber sample was then placed in an oven until the alcohol was removed, the material turned hard and crumbled.

Example 4—Repeating example 3, and added an vegetable oil to the elastic lignin kneading it into the material and left to dry. The material remained elastic for days, but felt very oily with little strength.

Example 5—Powdered lignin was melt blended with an ABS plastic at a 5% level. The performance of the ABS was stiffer with higher modulus of elasticity but was more brittle with less impact resistance. This was similar to that of simply adding a mineral filler to ABS.

The same test of ABS and 10% lignin was melt blended with a paper mill sludge mineral/fiber material and extruded into a profile shape and tested against the same blend and process without the lignin addition. We seen a doubling of the modulus of elasticity and modulus of rupture with the lignin addition to the fiber reinforced ABS with this small addition of lignin.

Example 6. —Powdered lignin was blended with propylene glycol at a 30% level of PPG. The material was liquid, but would not knead or dry out. A second batch was made wherein 40% alcohol was added to the lignin first, then an addition of 10% PPG was then added. The material was mixed and kneaded. As the alcohol evaporated, the material became a dough then a rubber with continued kneading. After sitting, the material retained a rubber state.

Example 7—The material made from Example 6 was then compounded with various thermoplastics including EVA and PE. The final product remained flexible and strong. Testing showed that by adjusting the amount of the PPG ration within the elastic lignin, the performance of the EVA and PE can be controlled from stiffer to more flexible.

Example 8—A mixture of powdered citric acid and isopropyl alcohol were mixed at 33 to 66 ratio wherein the citric acid was dissolved. This mixture was blended with powdered lignin at a ratio of approximately 50%. The material was still in a powder form with simple mixing. The material was then kneaded and formed an rubber ball that was less sticky than other examples. The material was left to sit overnight, but remained elastic.

Example 9—Using an organosolv process, biomass was separated wherein the lignin material was placed in a vessel and comprised approximately 80% alcohol. Butyl acetate carrier/dissolving agent was generated and also added with the lignin to create a black liquor material. The material was phase separated by gravity in which the alcohol/lignin layer was removed being separated from the aqueous layer. The material was then evaporated to remove the alcohol first, the butyl acetate carrier remained within the lignin to create a reactive melt flowable biopolymer. The material can be liquid or a solid at room temperature based on the amount of the residual carrier material. The room temperature solid can be molten at various temperature, but within this example the material melted at a temperature of approximately 220° F.

The phase separated liquid lignin from above was blended with a powdered thermal plastic, which also would dissolve in the residual butyl acetate. The materials were blended together under heat conditions until they formed a homogenous admixture. The alcohol was removed to form a material with elastomeric properties. It is to be understood that the above described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A method of recovering lignin from biomass comprising the steps of:
mixing biomass with a lignin solvent to form a mixture of biomass and solvent,
heating the mixture of biomass and solvent to allow at least a portion of lignin from the biomass to become soluble in the solvent,
separating a portion of solids from the lignin solvent,
separating an organic layer from the separated lignin solvent,
processing the organic layer to recover lignin or a concentrated form or lignin,
processing the organic layer or concentrated form of lignin to enhance the processibility of the organic layer, and/or
processing the organic layer or concentrated form of lignin to enhance the properties of the lignin.

2. The method of claim 1, wherein the biomass is lignocellulosic biomass, any form of biomass or agricultural residue, agricultural byproduct, or any plant based product to include, but not limited to wood biomass, algae, crop residue, kraft black liquor, recovered kraft lignin, lignosulfonate and cellulosic biorefinery byproducts.

3. The method of claim 1, wherein the lignin solvent is comprised of a water insoluble, non-polar or hydrophobic solvent.

4. The method of claim 1, wherein the lignin solvent contains n-butanol, methyl butenol or mixtures thereof.

5. The method of claim 1, wherein the lignin solvent is or contains a portion of any alcohol to include but not be limited to ethanol, methanol, n-butanol, isobutanol, glycerol, or mixtures thereof.

6. The method of claim 1, wherein the lignin solvent is or contains a fatty acid to include but not be limited to tall oil fatty acid, vegetable oil fatty acid, animal fat fatty acid, or mixtures thereof.

7. The method of claim 1, wherein the lignin solvent contains lignin.

8. The method of claim 1, wherein the lignin solvent can also include water, an acid, and/or a lignin dissolving chemical comprising of one of an organic ester, butyl acetate, an organic furan, and furfural, the acid is comprised of sulfuric, acetic, citric, nitric, hydrochloric, hydrobromic, hydroiodic, perchloric, chloric, formic, benzoic, methanoic, hydrofluoric, nitrous, phosphoric, hydrogen sulfate, sulfurous or oxalic acid or any combinations thereof.

9. The method of claim 1, wherein the mixture of biomass and lignin solvent is heated to a temperature: greater than 20° C. and less than 400° C., greater than 50° C. and less than 250° C., greater than 100° C. and less than 250° C., greater than 100° C. and less than 225° C., or greater than 100° C. and less than 200° C., greater than 150° C. and less than 250° C., greater than 150° C. and less than 225° C., greater than 150° C. and less than 200° C., or greater than 100° C. and less than 180° C. in a reactor and the reactor pressure is equal or greater than the vapor pressure of the lignin solvent and at the process operating temperature to prevent boiling or control the vaporization of the lignin solvent.

10. The method of claim 1, wherein the mixture of biomass and lignin solvent, at any given operating temperature, has an operating pressure: equal to the corresponding lignin solvent vapor pressure, between 0 psig and 50 psig above the solvent vapor pressure, between 15 psig and 75 psig above the solvent vapor pressure, between 50 psig and 100 psig above the solvent vapor pressure, between 75 psig and 250 psig above the solvent vapor pressure, between 150 and 450 psig above the solvent vapor pressure, between 300 and 600 psig above the solvent vapor pressure, or between 500 and 2000 psig above the solvent vapor pressure at the given operating temperature.

11. The method of claim 1, wherein the liquid separation system only separates a portion of the materials and may have carryover or significant carryover of liquids in the separated solids stream or solids in the separated liquids stream.

12. The method of claim 1, wherein the separated liquids stream from the liquid-solids separation system is further processed to include a liquid-liquid separation system such as, but not limited to, density separation, gravity separation, decanting, centrifugal separation, chemical separation, evaporation, distillation, membrane separation or other recognized liquid-liquid separation method.

13. The method of claim 1, wherein the separated liquids stream from the liquid-solids separation system is divided into two primary streams, a first of the primary streams is of lower density than a second of the primary streams, the first primary stream comprises water and the second primary stream comprises organic solvent where the organic solvent can be comprised of one or more of: an alcohol, n-butanol, isobutanol, butyl acetate, lignin and/or furfural.

14. The method of claim 1, wherein the separated organic layer stream is further processed in an evaporation system or distillation system to remove a portion of the organic solvents from the lignin to produce a more concentrated form of lignin within the remaining organic layer.

15. The method of claim 1, wherein a carrier material is added to the organic layer or partially evaporated organic layer.

16. The method of claim 15, wherein the carrier material has a vapor pressure lower than many of the lignin solvents within the organic layer such that the carrier material and lignin are heated to allow the lignin to remain in a fluid-like environment as the mixture is heated to a temperature that allows a portion of the lignin solvent to vaporize and be separated and recovered.

17. The method of claim 15, wherein the carrier material is a vegetable oil, mineral oil, fatty acid, butanol, petroleum derived liquids such as crude oil and diesel, or polymeric materials such as nitrile rubber, polyethylene, polyethylene oxide, polypropylene, glycerol, phenol or mixtures thereof.

18. The method of claim 14, wherein a functional material is be added to the lignin or concentrated form of lignin.

19. The method of claim 18, wherein the optional functional material is a functional additive, polymer, thermoplastic, fire retardant, cross linker, chain extender, catalyst, plasticizer, polyol or blends thereof.

20. The method claim 18, wherein the functional material is comprised of a Plasticizer, MMA, PMMA Acrylic, Esters, waxes, Oils, acids, Rubber, Thermplastics, Bioplastics, Fillers, Fibers, minerals, Fire retardant, Colorants, whitening agents, PAN polyacrylonitrile, Polyols or combinations thereof.
